(19) United States
(12) Patent Application Publication
(10) Pub. No.: US 2018/0207596 A1
(43) Pub. Date: Jul. 26, 2018

(54) SUPERCRITICAL SYNTHETIC Y-GRADE NGL

(71) Applicants: John A. BABCOCK, Houston, TX (US); Linde Aktiengesellschaft, Munich (DE)

(72) Inventors: John A. BABCOCK, Houston, TX (US); Charles P. SIESS, III, Conroe, TX (US)

(21) Appl. No.: 15/413,870

(22) Filed: Jan. 24, 2017

(51) Int. Cl. B01J 3/00; C09K 3/00; C11D 7/24; C11D 11/00; C08J 9/14

(52) U.S. Cl. CPC B01J 3/008; C09K 3/00; C11D 7/24; C11D 11/0047; C08J 2300/00; C08J 9/141; C08J 2203/08; C08J 2203/14; C11D 11/0023

(57) ABSTRACT

Use of a synthetic form of Y-grade natural gas liquids when in a supercritical state for a variety of processes and across numerous industrial applications is described herein. The low viscosity, high density, and tunable solvent properties of synthetic supercritical Y-grade natural gas liquids are useful for example in control of chemical reactions and processes, and/or single or two-phase separations.

### BACKGROUND

### Field

Embodiments of the disclosure relate to using a synthetic hydrocarbon mixture when in a supercritical state.

### Description of the Related Art

A supercritical fluid (SCF) is any substance at a temperature and pressure above its critical point, where distinct liquid and gas phases do not exist. It can effuse through solids like a gas, and dissolve materials like a liquid. In addition, close to the critical point, small changes in pressure or temperature result in large changes in density, allowing many properties of a supercritical fluid to be “fine-tuned”. Frequently the term “compressed liquid” is used to indicate a supercritical fluid, a near-critical fluid, an expanded liquid, or a highly compressed gas.

A SCF has densities similar to that of liquids, while the viscosities and diffusivities are closer to that of gases. Thus, a SCF can diffuse faster in a solid matrix than a liquid, yet possess a solvent strength sufficient to extract a solute from the solid matrix. SCF's also have unique solution properties stemming from their behavior near the critical point. It is frequently observed that SCF's exhibit a “retrograde” behavior near their critical point where an increase in temperature of the SCF increases solubility of a solute in some pressure ranges while decreasing solubility of the solute in other pressure ranges.

Chemical and petrochemical processing relies heavily on use of solvents and solutions, and there is always a need for versatile hydrocarbon-based solvents in the chemical and petrochemical industries.

### SUMMARY

A method of using a supercritical fluid comprises providing a synthetic hydrocarbon mixture comprising a synthetic form of Y-Grade NGL, and maintaining the synthetic hydrocarbon mixture at a pressure and a temperature above a critical point such that the synthetic hydrocarbon mixture is in a supercritical state where distinct liquid and gas phases do not exist.

### BRIEF DESCRIPTION OF THE DRAWINGS

FIG. 1 is a phase diagram of a synthetic hydrocarbon mixture similar in composition to Y-Grade NGL according to one embodiment.

FIG. 2 is a schematic of a synthetic hydrocarbon mixture mixing system according to one embodiment.

FIG. 3 is a schematic of synthetic hydrocarbon mixture mixing system according to one embodiment.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

Embodiments of the disclosure include the use of a synthetic hydrocarbon mixture in a supercritical state across a variety of industrial applications.

Y-Grade natural gas liquids (“NGL”) can be useful for industrial applications when in a supercritical state because of the variability of the composition of Y-Grade NGL. In its natural form, however, the composition of Y-Grade NGL unpredictably varies depending on various factors. For example, the ethane content in Y-Grade NGL can vary from as low as 10% by volume ethane (C2) to as high as 50% by volume ethane (C2) depending upon the source (e.g. a shale basin) from which the Y-Grade NGL is produced and whether the ethane is being rejected as the Y-Grade NGL is being produced. When ethane is being rejected (e.g. being sold with methane sales gas), the ethane composition of the Y-Grade NGL usually reaches its minimum value.

Having a predictable Y-Grade NGL composition, such as by creating a synthetic form of Y-Grade NGL, with associated supercritical conditions is required for precise engineering processes. For example, the critical point of a synthetic hydrocarbon mixture comprising a synthetic form of Y-Grade NGL can be controlled and adjusted by varying the composition of the Y-Grade NGL. This would allow for the customization of a critical point for specific engineering processes.

A synthetic hydrocarbon mixture comprising a synthetic form of Y-Grade NGL (herein referred to as Synthetic Y-Grade NGL) can be created by mixing each alkane via mass fraction mixing by batch mixing or mixing on the fly. The Synthetic Y-Grade NGL has a composition substantially similar to the natural form of Y-Grade NGL. The natural form of Y-Grade NGL, which is a by-product of a de-methanized hydrocarbon stream, is an un-fractionated hydrocarbon mixture comprising ethane, propane, butane, isobutane, and pentane plus. Pentane plus comprises pentane, isopentane, and/or heavier weight hydrocarbons, for example hydrocarbon compounds containing at least one of C5 through C8+. Pentane plus may include natural gasoline for example. Thus, Synthetic Y-Grade NGL comprises ethane, propane, butane, isobutane, and pentane plus.

Synthetic Y-Grade NGL is comprised of several NGL purity products. An NGL purity product is defined as an NGL stream having at least 90% of one type of carbon molecule. The five recognized NGL purity products are ethane (C2), propane (C3), normal butane (NC4), isobutane (IC4) and natural gasoline (C5+).

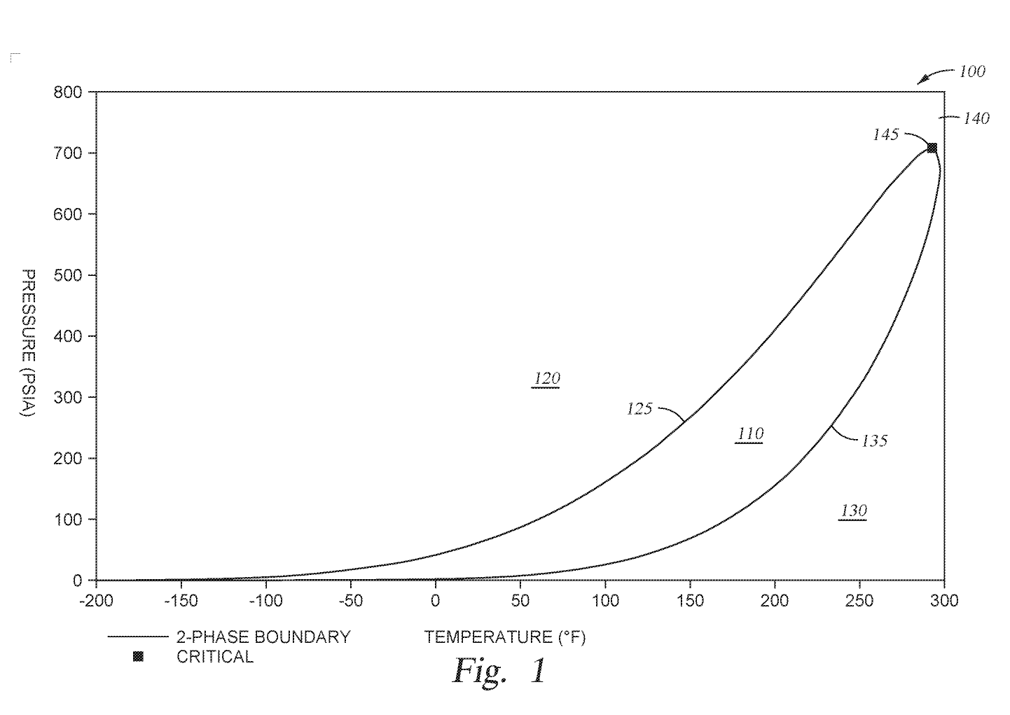

FIG. 1 is a phase diagram 100 for a mixture of Synthetic Y-Grade NGL, according to one embodiment. The mixture of Synthetic Y-Grade NGL comprises about 12.2% ethane, about 37.8% propane, about 34.2% butane, about 8.4% pentane, about 4.9% hexane, about 1.6% heptane, and about 0.9% octane. The phase diagram 100 illustrates a two-phase region 110 where both gas and liquid exists, a liquid region 120, and a gas region 130.

The bubble point curve, e.g. the point at which a gas-phase first appears, is shown by boundary line 125. The dew point curve, e.g. the point at which a liquid-phase first appears, is shown by boundary line 135. The critical point, e.g. the point at a temperature and a pressure beyond which liquid and gas no longer exist as separate phases, is shown by critical point 145. The critical point 145 is at a pressure about 700 psia and at a temperature about 280° F. The area where the Synthetic Y-Grade NGL exists as a supercritical fluid, e.g. is in a supercritical state, is in supercritical region 140 which is at a temperature and a pressure above the critical point 145.

According to the phase diagram 100, the Synthetic Y-Grade NGL is in a supercritical state when at a pressure above about 700 pounds per square inch (psia), for example about 705-710 psia, and at a temperature above about 280° F., for example about 285-290° F. Synthetic Y-Grade NGL when in a supercritical state acts as a supercritical fluid that can be used across a broad range of industrial applications.

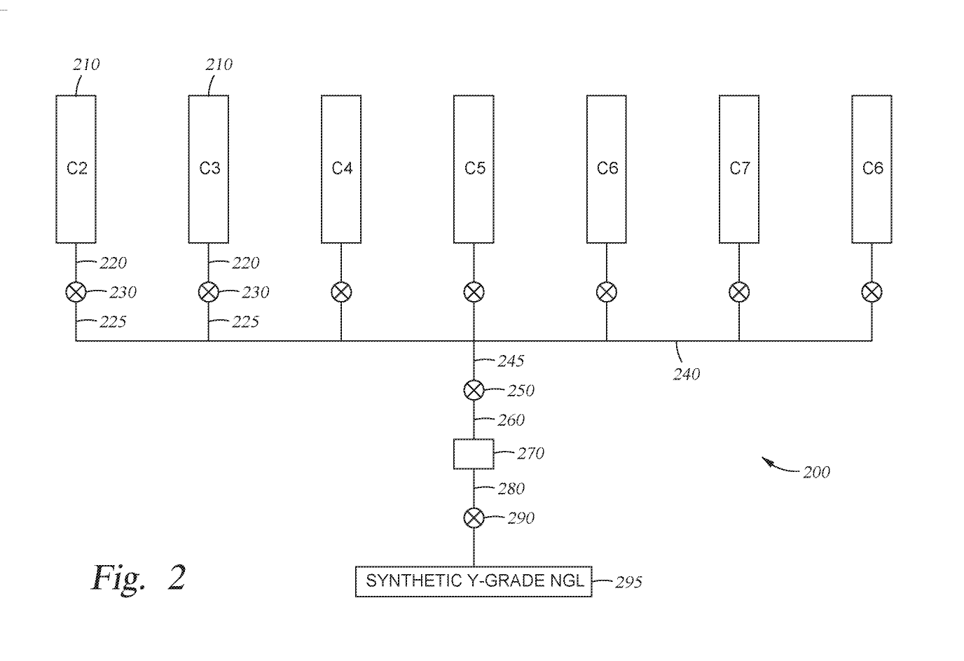

FIG. 2 is a schematic illustration of a synthetic hydrocarbon mixture mixing system 200. Alkanes ranging from ethane (C2) to octane (C8) are individually contained as liquids in one or more pressurized containers 210. Each liquid alkane is separately and individually flowed from the respective pressurized containers 210 via line 220, through control valve 230, and discharged into header line 240 via line 225. The header line 240 discharges into line 245 to mass flow meter 250 whereby a predetermined mass of the liquid alkane is allowed to flow into line 260. The predetermined mass of the liquid alkane exits the mass flow meter 250 and flows into a pump 270 via line 260, which pumps the liquid alkane through control valve 290 via line 280 and into a storage vessel 295. The pump 270 boosts the pressure of the liquid alkane to a desired pressure at which the liquid alkane is to be stored in the storage vessel 295.

After the desired quantity of one alkane is pumped into the storage vessel 295, a desired quantity of a different alkane is pumped into the storage vessel 295, where it mixes with the alkanes previously pumped into the storage vessel 295. Each alkane may be pumped into the storage vessel 295 in any order. The process is repeated for each alkane until a desired amount and composition of alkanes are mixed in the storage vessel 295 to create a synthetic form of Y-Grade NGL. The synthetic hydrocarbon mixture mixing system 200 is thus used to form any amount of Synthetic Y-Grade NGL having a specific composition for a desired application.

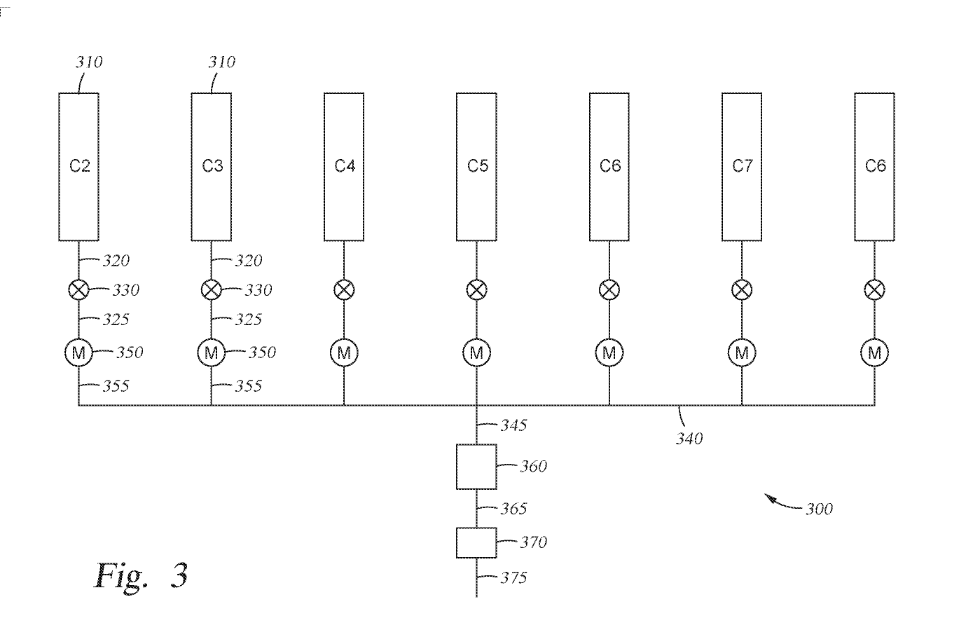

FIG. 3 is a schematic illustration of a synthetic hydrocarbon mixture mixing system 300. Alkanes ranging from ethane (C2) to octane (C8) are individually contained as liquids in one or more pressurized container 310. Each liquid alkane is separately but simultaneously flowed with the other liquid alkanes from the respective pressurized containers 310, through control valves 330 via lines 320 and through respective mass flow meters 350 via lines 325. A predetermined mass of each liquid alkane discharges in proper amounts into header line 340 via lines 355. The proportional mass of each liquid alkane exits header line 340 and flows into an inline static mixer 360 via line 345. The various proportions of alkanes are mixed by the inline static mixer 360 to create a synthetic form of Y-Grade NGL having a specific composition for a desired application.

The Synthetic Y-Grade NGL flows into a pump 370 via line 365 to boost the pressure to a desired pressure before being discharged via line 375. Each alkane is continuously and simultaneously supplied into the inline static mixer 360 to provide a steady state flow of Synthetic Y-Grade NGL having a specific composition. The synthetic hydrocarbon mixture mixing system 300 is thus used to form any amount of Synthetic Y-Grade NGL having a specific composition for a desired application.

Various compositions of Synthetic Y-Grade NGL can be created using any of the systems 200, 300 for use in a supercritical state. The composition of Synthetic Y-Grade NGL can be varied to increase or decrease the temperature and/or pressure of the critical point at which the Synthetic Y-Grade NGL is in a supercritical state for a desired application. For example, any one or more of the amount of ethane, propane, butane, isobutane, and/or pentane plus of a Synthetic Y-Grade NGL composition can be increased or decreased to increase or decrease the temperature and/or pressure of the critical point at which the Synthetic Y-Grade NGL is in a supercritical state.

Extraction of polymers can be done using Synthetic Y-Grade NGL when in a supercritical state. Polymers can uptake a significant amount of the supercritical Synthetic Y-Grade NGL. As the concentration of the compressed fluid is increased in the polymer phase, the sorption and subsequent swelling of an amorphous polymer can cause a glass-to-liquid-phase transition. The glass transition temperature of the polymer may be drastically reduced and this behavior may be exploited in polymer processing to produce extremely small voids only a few micrometers in diameter.

Enzymatic reactions in non-aqueous media, especially supercritical fluids, are gaining acceptance. The density of supercritical Synthetic Y-Grade NGL is comparable to that of liquids, while the viscosities and diffusion coefficients are comparable to that of gases. This enhances the rates for diffusion controlled reactions. Supercritical Synthetic Y-Grade NGL has application to enzymatic reactions.

The ability to design surfactants for the interface between water and supercritical Synthetic Y-Grade NGL offers new avenues in protein and polymer chemistry, separation science, reaction engineering, waste minimization and treatment. Surfactant design is well understood for conventional reverse micelles and water-in-oil microemulsions for alkane solvents.

Fractionation is difficult to achieve in distillation because the impurities have about the same volatility as the primary components reducing the overall selectivity. Supercritical Synthetic Y-Grade NGL can be used to fractionate low vapor pressure oils and polymers. The low vapor pressure material or polymer is exposed to the supercritical Synthetic Y-Grade NGL prior to the fractionation to form a material mixture in which the supercritical Synthetic Y-Grade NGL can dissolve the material. The material mixture is maintained in supercritical state during the dissolving process by maintaining temperature and/or pressure near the critical point 145 of the Synthetic Y-Grade NGL. The material mixture is then fractionated by applying a differential temperature, pressure, or both (e.g. adjusting at least one of pressure and temperature) to the supercritical Synthetic Y-Grade NGL.

Supercritical Synthetic Y-Grade NGL is an attractive media for several chemical reactions. By small adjustments in pressure, the reaction rate constants can be altered by two orders of magnitude. Equilibrium constants for reversible reactions can also be changed 2-6 fold by small changes in pressure. This dramatic control over the reaction rates has led to the design of several reactions in different areas of biochemistry, polymer chemistry and environmental science. Supercritical Synthetic Y-Grade NGL can be used for adjusting the rate of reaction in several chemical reactions.

Supercritical Synthetic Y-Grade NGL GL can be used extensively in the material and polymer industry. Rapid expansion from supercritical solutions across an orifice or nozzle is used commercially to precipitate solids. In this technique, a solute dissolved in supercritical Synthetic Y-Grade NGL is depressurized rapidly. By controlling the operating variables carefully, the desired precipitated morphology can be attained.

Solubilities and recrystallization of various drugs has been demonstrated in supercritical fluids. Since the residual solvent present in the extracted material is of critical importance in the pharmaceutical industry, supercritical Synthetic Y-Grade NGL can be found to have several applications.

The use of supercritical Synthetic Y-Grade NGL as an anti-solvent while modifying operating parameters, nozzle shapes and material properties can generate engineered structures such as nano-spheres, empty balloons, microfibers, microencapsulation and supercritical suspensions.

The use of supercritical Y-Grade NGL as a high diffusivity solvent is the basis of supercritical impregnation. The supercritical Synthetic Y-Grade NGL is a powerful solvent that can impregnate even in the smallest pores of the matrix (when porous).

Supercritical Synthetic Y-Grade NGL provides a type of solvent for conducting reactions. Supercritical Synthetic Y-Grade NGL is a tunable solvent whereby the density, reaction rate, yield, and selectivity can be controlled.

Supercritical Synthetic Y-Grade NGL can be used in numerous industrial applications including fractionation, byproduct extraction, surfactant purification, manufacturing of foams and aerogels, anti-solvent for nano-particles, petrochemical suspensions, micro-encapsulation fluid, impregnation fluid, tunable solvent, and recrystallization of pharmaceuticals fluid.

In one embodiment, a method of separating a low vapor pressure material comprises forming a mixture of the low vapor pressure material with supercritical Synthetic Y-Grade NGL; and fractionating the mixture by a process that includes differential temperature, differential pressure, or both.

In one embodiment, a method of performing a chemical reaction comprises forming a mixture of one or more reactants in supercritical Synthetic Y-Grade NGL; maintaining the supercritical state of the supercritical Synthetic Y-Grade NGL while performing a chemical reaction with one of the one or more reactants; and adjusting the supercritical properties of the supercritical Synthetic Y-Grade NGL by adjusting the temperature, pressure, or both, of the supercritical Synthetic Y-Grade NGL.

In one embodiment, a solid-liquid separation method comprises exposing a solid having an absorbed liquid to supercritical Synthetic Y-Grade NGL; and separating at least a portion of the absorbed liquid from the solid using the supercritical Synthetic Y-Grade NGL as a solvent.

In one embodiment, a method of forming voids in a polymer matrix comprises contacting the polymer matrix with supercritical Synthetic Y-Grade NGL; intercalating the supercritical Synthetic Y-Grade NGL into the polymer matrix; and vaporizing the supercritical Synthetic Y-Grade NGL to form a void in the polymer matrix.

In one embodiment, a method of performing an enzymatic reaction comprises forming a mixture of an enzyme and a target in supercritical Synthetic Y-Grade NGL; and controlling diffusion of the enzyme and the target in the mixture by adjusting the temperature, pressure, or both, of the supercritical Synthetic Y-Grade NGL.

In one embodiment, a method of performing a liquid interface process comprises disposing a liquid having a surface in a container; applying a layer of supercritical Synthetic Y-Grade NGL to the surface of the liquid; and performing a liquid interface process while maintaining the supercritical Synthetic Y-Grade NGL in a supercritical state.

In one embodiment, supercritical Synthetic Y-Grade NGL may be used to modify equilibrium constants for reversible reactions in areas of biochemistry, polymer chemistry and environmental science; commercially precipitate solids into desired morphologies; recrystallize various drugs found in the pharmaceutical industry; as an anti-solvent to generate engineered structures such as nano-spheres, empty balloons, microfibers, microencapsulation and supercritical suspensions; as a solvent to impregnate the smallest pores of a solid matrix (when porous); to generate foams and aerogels; for gas an liquid chromatography; for heterogenous and homogeneous catalytic reactions; for chemical synthesis; for reactive deposition; for continuous hydrogenation of organic compounds, for extraction of metals; and for inorganic and metal-organic co-cordination chemistry.

In one embodiment, an synthetic hydrocarbon mixture, such as Synthetic Y-Grade NGL, in a supercritical state can be used for and in the following processes and industrial applications:

Extraction from solid materials, which could include polymer stripping;

Fractionation of difficult to extract aromatics, polymers, and poly unsaturated fatty acids;

Reactions in large scale petrochemical plants, for instance butene hydration to 2-butenal, and in fine chemistry, for instance highly selective synthesis;

With paints and coatings, including powder coatings for suspension of polymers and pigments, and to reduce paint viscosity;

In polymer processing, such as to generate plasticizers, impregnation, extraction of residues, morphology modifications, and blending alloys;

In ceramics, such as ceramic binder extraction;

In foams and aerogels, such as polymeric foams, microcellular foams, and thermoplastics, and for drying of aerogels and cyclical aerogels using Synthetic Y-Grade NGL;

In particle design, manufacturing particles using the rapid expansion of supercritical Synthetic Y-Grade NGL, and for engineered structures, including nanospheres, empty balloons, and hollow microfibers;

In Impregnation, such as a tunable solvent, to impregnate matrix porosity, and dyeing of synthetic fibers;

In cleaning, such as degreasing of mechanical and/or electrical parts; and

In reaction media, such as enzymatic reactions and oxidation, density or co-solvent tunings of reaction rates and yields, improved mass transfer, and simultaneous separation with reaction.

While the foregoing is directed to certain embodiments, other and further embodiments may be devised without departing from the basic scope of this disclosure.

1. A method of using a supercritical fluid, comprising:
providing a synthetic hydrocarbon mixture comprising a synthetic form of Y-Grade NGL; and
maintaining the synthetic hydrocarbon mixture at a pressure and a temperature above a critical point such that the synthetic hydrocarbon mixture is in a supercritical state where distinct liquid and gas phases do not exist.

2. The method of claim 1, further comprising adjusting the critical point by varying the proportions of alkanes of the synthetic form of Y-Grade NGL.

3. The method of claim 1, wherein the synthetic form of Y-Grade NGL comprises up to about 50% ethane.

4. The method of claim 1, further comprising mixing the synthetic hydrocarbon mixture when in the supercritical state with a low vapor pressure material to form a material mixture, and fractionating the material mixture by adjusting at least one of pressure and temperature.

5. The method of claim 1, further comprising mixing the synthetic hydrocarbon mixture when in the supercritical state with one or more reactants to form a reactant mixture, and performing a chemical reaction with one of the one or more reactants while maintaining the synthetic hydrocarbon mixture in the supercritical state.

6. The method of claim 1, further comprising mixing the synthetic hydrocarbon mixture when in the supercritical state with a solid having an absorbed liquid, and separating at least a portion of the absorbed liquid from the solid by using the synthetic hydrocarbon mixture when in the supercritical state as a solvent.

7. The method of claim 1, further comprising contacting the synthetic hydrocarbon mixture when in the supercritical state with a polymer matrix, intercalating the synthetic hydrocarbon mixture when in the supercritical state into the polymer matrix, and vaporizing the synthetic hydrocarbon mixture to form a void in the polymer matrix.

8. The method of claim 1, further comprising mixing the synthetic hydrocarbon mixture when in the supercritical state with an enzyme and a target, and controlling diffusion of the enzyme and the target using the synthetic hydrocarbon mixture when in the supercritical state.

9. The method of claim 1, further comprising applying a layer of the synthetic hydrocarbon mixture when in the supercritical state onto a surface of a liquid in a container, and preforming a liquid interface process using the synthetic hydrocarbon mixture when in the supercritical state.

10. The method of claim 1, further comprising drying an aerogel using the synthetic hydrocarbon mixture when in the supercritical state.

11. The method of claim 1, further comprising manufacturing particles using the synthetic hydrocarbon mixture when in the supercritical state.

12. The method of claim 1, further comprising impregnating a porous matrix using the synthetic hydrocarbon mixture when in the supercritical state.

13. The method of claim 1, further comprising degreasing mechanical or electrical parts using the synthetic hydrocarbon mixture when in the supercritical state.
